(19) United States
(12) Patent Application Publication
(10) Pub. No.: US 2011/0252442 A1
(43) Pub. Date: Oct. 13, 2011

(54) METHOD AND APPARATUS FOR TUNING TO PROGRAM CHANNEL BASED ON SOUND SAMPLE IN MOBILE COMMUNICATION TERMINAL

(75) Inventors: Yuanyuan CUI, Beijing (CN); Qian WANG, Bejing (CN)

(73) Assignee: SONY ERICSSON MOBILE COMMUNICATIONS AB, LUND (SE)

(21) Appl. No.: 13/079,342

(22) Filed: Apr. 4, 2011

(30) Foreign Application Priority Data
Apr. 9, 2010 (CN) 201010147533.4

(51) Int. Cl. H04N 5/445

(52) U.S. Cl. 725/38

(57) ABSTRACT

A method and an apparatus for tuning a program channel based on a sound sample in a mobile communication terminal are disclosed. The apparatus includes: a sound sample acquiring unit configured to acquire a sound sample of a predetermined period of time in a predetermined format, with respect to a program including audio played by a program playing source; a transmitting unit configured to transmit the sound sample to a server over a network, so as to acquire corresponding program channel information based on the sound sample; a receiving unit configured to receive the acquired program channel information; and a tuning and playing unit configured to tune to an appropriate program channel based on the received program channel information so as to receive and play a corresponding program. With the present disclosure, the user can conveniently tune the mobile communication terminal to an appropriate program channel based on the sound of the program so as to receive and play the program, instead of recognizing the channel information of a program being played himself.

### FIELD OF THE DISCLOSURE

The present disclosure relates to a technique of conveniently tuning to a program channel in a mobile communication terminal, and particularly, to a method and an apparatus for tuning to a program channel in a mobile communication terminal based on a sound sample to play a program, the mobile communication terminal including the apparatus, and a program channel information retrieval server that feeds back program channel information to the mobile communication terminal.

### BACKGROUND OF THE DISCLOSURE

In the lives of people, such a situation will usually occur that you suddenly have to leave due to other things while watching a hot TV series (as used herein “TV” is an abbreviation for “television”), and then you miss the climax of the story, which is a pity more or less.

With the development of the mobile communication technique, especially the development of the third generation of mobile communication network, most of the mobile phones at present have the function of radio application and even mobile TV application. Therefore, under the above situation or a situation that the user is far away from the TV set while hearing that a program of interest is played, he can adopt a mobile phone to listen/watch the program, instead of going to sit before the TV set. Thus, for example even during a walk, the user will not miss a program in which he is interested.

However, the user cannot listen/watch unless he firstly knows a channel in which the concerned program is played and then performs a proper tuning operation. This brings extra inconvenience to the user, especially when the user is not in front of the TV set, for example when the user hears that a TV program in which he is interested or likes is played while passing by a certain place accidentally, and it is inconvenient for the user to determine the channel in which the program is played.

Therefore, a technique is needed to automatically tune the mobile phone to a corresponding channel according to the sound played by the TV set (or radio set), so as to play the corresponding program.

### SUMMARY OF THE DISCLOSURE

The present disclosure is provided in view of the above problem and need of the prior art. The present disclosure relates to a technique that enables a mobile phone to automatically tune to a corresponding channel according to the sound played by the TV set (or radio set), so as to play a corresponding program.

A first aspect of the present disclosure provides an apparatus for tuning to a program channel based on a sound sample in a mobile communication terminal, which includes:

a sound sample acquiring unit configured to acquire a sound sample of a predetermined period of time in a predetermined format from a program including audio played by a program playing source;

a transmitting unit configured to transmit the sound sample acquired by the sound sample acquiring unit to a server over a network, so as to acquire corresponding program channel information based on the sound sample;

a receiving unit configured to receive the acquired program channel information; and

a tuning and playing unit configured to tune to an appropriate program channel based on the program channel information received by the receiving unit, so as to receive over the network and play a program corresponding to the program channel information.

A second aspect of the present disclosure provides an apparatus based on the first aspect, wherein the predetermined period of time is longer than predetermined minimum sound sample duration for acquiring program channel information based on the sound sample.

A third aspect of the present disclosure provides an apparatus based on the first aspect wherein the tuning and playing unit is further configured to, based on the program channel information received by the receiving unit and program playing applications supported by the mobile communication terminal, select an appropriate one of the program playing applications to play the program corresponding to the program channel information.

A fourth aspect of the present disclosure provides an apparatus based on the third aspect, wherein the mobile communication terminal includes a mobile TV application,

and wherein, when the program channel information received by the receiving unit indicates a TV program source, the tuning and playing unit selects the mobile TV application to play the program corresponding to the program channel information.

A fifth aspect of the present disclosure provides an apparatus based on the first aspect, which further includes a program channel information presenting and selecting unit configured to, when the receiving unit receives more than one piece of program channel information, present the more than one piece of program channel information to the user for the user's selection, and

wherein the tuning and playing unit is further configured to, based on the program channel information selected by the user through the program channel information presenting and selecting unit, tune to an appropriate channel to receive over the network and play the program corresponding to the selected program channel information.

A sixth aspect of the present disclosure provides an apparatus based on the first aspect, wherein when the transmitting unit fails to successfully transmit the sound sample acquired by the sound sample acquiring unit to the server over the network within predetermined time, the sound sample acquiring unit re-acquires a sound sample of the program.

A seventh aspect of the present disclosure provides a mobile communication terminal, which includes the apparatus according to any of the first aspect to the sixth aspect.

An eighth aspect of the present disclosure provides a method for tuning to a program channel based on a sound sample in a mobile communication terminal, which includes:

activating a sound sample-based tuning function of the mobile communication terminal;

acquiring, by the mobile communication terminal, a sound sample of a predetermined period of time in a predetermined format from a program including audio played by a program playing source;

transmitting, by the mobile communication terminal, the acquired sound sample to a server over a network, so as to acquire corresponding program channel information based on the sound sample; and

tuning, by the mobile communication terminal, to an appropriate program channel based on the received program channel information, so as to receive over the network and play a program corresponding to the program channel information.

A ninth aspect of the present disclosure provides a method based on the eighth aspect, wherein the predetermined period of time is longer than predetermined minimum sound sample duration for acquiring program channel information based on the sound sample.

A tenth aspect of the present disclosure provides a method based on the eighth aspect, wherein the step of playing the program includes: selecting, by the mobile communication terminal, based on the received program channel information and program playing applications supported by the mobile communication terminal, an appropriate one of the program playing applications so as to play the program corresponding to the program channel information.

An eleventh aspect of the present disclosure provides a method based on the tenth aspect, wherein when the program channel information received by the mobile communication terminal indicates a TV program source, and if the mobile communication terminal includes a mobile TV application, the program corresponding to the program channel information is played by the mobile TV application.

A twelfth aspect of the present disclosure provides a method based on the eighth aspect, which further includes:

when more than one piece of program channel information is received, presenting the more than one piece of program channel information to the user for the user's selection, and

wherein playing the program further includes: based on the program channel information selected by the user, tuning to an appropriate channel so as to receive over the network and playing the program corresponding to the selected program channel information.

A thirteenth aspect of the present disclosure provides a method based on the eighth aspect, which further includes:

if the acquired sound sample is not successfully transmitted to the server over the network within the predetermined time, re-acquiring a sound sample of the program.

A fourteenth aspect of the present disclosure provides a program channel information retrieval server, which includes:

a tracking and decoding unit configured to track and decode in real-time, audio information of program channels of at least one program source connected to the server, and acquire sound samples of a first predetermined period of time in a predetermined format, based on the decoded audio information from the program channel(s) (meaning one or more program channels) of the program sources;

a storing unit configured to store the program channel information of the program channels of the program sources and the sound samples acquired by the tracking and decoding unit in a predetermined time interval from the program channels, into a database in association with each other;

a comparing unit configured to compare a sound sample of a second predetermined period of time received from a mobile communication terminal via a network with the sound samples associated with respective program channels of respective program source(s) stored in the database, so as to determine program channel information corresponding to the received sound sample, wherein the sound sample of the second predetermined period of time is acquired by the mobile communication terminal in the predetermined format from a program including audio being played by a program playing source; and

a feedback unit configured to feedback the determined program channel information to the mobile communication terminal via the network, so that the mobile communication terminal is capable of tuning to an appropriate program channel based on the fed back program channel information to receive and play the program corresponding to the program channel information.

A fifteenth aspect of the present disclosure provides a program channel information retrieval server based on the fourteenth aspect, wherein the tracking and decoding unit is further configured to receive in real-time from each program source, a transmission stream multiplexing audio/video data streams of program channels of the program source, so as to decode audio information of each program channel of the program source from the received transmission stream.

A sixteenth aspect of the present disclosure provides a program channel information retrieval server based on the fourteenth aspect, wherein the first predetermined period is determined at least based on the second predetermined period, a transmission delay for transmitting the sound sample from the mobile communication terminal to the program channel information retrieval server, the predetermined time interval and a minimum sound sample duration for acquiring program channel information through sound comparison.

A seventeenth aspect of the present disclosure provides a program channel information retrieval server based on the fourteenth aspect is provided, wherein the comparing unit is further configured to select, based on a location of the mobile communication terminal determined by the network, a program source corresponding to the location and compare the received sound sample with the sound samples associated with respective program channels of the selected program source stored in the database.

An eighteenth aspect of the present disclosure provides a program channel information retrieval server based on the fourteenth aspect, wherein the comparing unit is further configured to carry out correlation operations respectively on the sound sample transmitted from the mobile communication terminal and the sound samples associated with respective program channels stored in the database, and if an obvious peak occurs in a result of correlation operation on the sound sample transmitted from the mobile communication terminal and one of the sound samples stored in the database, as compared with the results of other correlation operations, determine that a program channel corresponding to the one sound sample is the program channel played by the program playing source when the mobile communication terminal acquires the sound sample.

A nineteenth aspect of the present disclosure provides a method for acquiring program channel information based on a sound sample in a program channel information retrieval server, wherein the program channel information retrieval server is connected to at least one program source so as to acquire program related information from the at least one program source, wherein the method includes:

tracking and decoding in real-time, audio information of program channels of the at least one program source;

acquiring a sound sample of a first predetermined period of time in a predetermined format, based on the decoded audio information from each program channel of each program source;

storing the program channel information of each program channel of each program source and a sound sample acquired in a predetermined time interval from the program channel, into a database in association with each other;

receiving a sound sample of a second predetermined period of time in the predetermined format from a mobile communication terminal;

comparing the received sound sample with the sound samples associated with respective program channels of respective program source(s) stored in the database, so as to determine program channel information corresponding to the received sound sample; and

feeding back the determined program channel information to the mobile communication terminal

A twentieth aspect of the present disclosure provides a method based on the nineteenth aspect, wherein the step of tracking and decoding in real-time, audio information of program channels of the at least one program source includes:

receiving in real-time from each program source, a transmission stream multiplexing audio/video data streams of each program channel of the program source, and decoding audio information of each program channel of each program source from the received transmission stream.

A twenty-first aspect of the present disclosure provides a method based on the nineteenth aspect, wherein the first predetermined period is determined at least based on the second predetermined period, a transmission delay for transmitting the sound sample from the mobile communication terminal to the program channel information retrieval server, the predetermined time interval and a minimum sound sample duration for acquiring program channel information through sound comparison.

A twenty-second aspect of the present disclosure provides a method based on the nineteenth aspect, wherein the step of comparing the sound samples includes:

selecting, based on a location of the mobile communication terminal transmitted together with the sound sample acquired by the mobile communication terminal, a program source corresponding to the location and compare the received sound sample with the sound samples associated with respective program channels of the selected program source stored in the database.

A twenty-third aspect of the present disclosure provides a method based on the nineteenth aspect, wherein the step of comparing the sound samples includes:

carrying out correlation operations respectively on the sound sample transmitted from the mobile communication terminal and the sound samples associated with respective program channels stored in the database; and

if an obvious peak occurs in a result of correlation operation on the sound sample transmitted from the mobile communication terminal and one of the sound samples stored in the database, as compared with the results of other correlation operations, determining that a program channel corresponding to the one sound sample is the program channel played by the program playing source when the mobile communication terminal acquires the sound sample.

A twenty-fourth aspect of the present disclosure provides a system for determining program channel information based on a sound sample, which includes the mobile communication terminal according to the seventh aspect, and the program channel information retrieval server according to any of the fourteenth aspect to the eighteenth aspect.

According to the present disclosure, the user can conveniently tune the mobile communication terminal to an appropriate program channel based on the sound of a program, so as to receive and play the program, instead of recognizing by himself the channel information of a program being played.

Those and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprise(s)/comprising” and “include(s)/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. The same element is represented with the same reference number throughout the drawings. In the drawings:

FIG. 1 is a schematic diagram illustrating an example configuration of a system according to an embodiment of the present disclosure, in which a mobile phone acquires program channel information based on a sound sample acquired from a TV set;

FIG. 2 is a flowchart illustrating a procedure according to an embodiment of the present disclosure, in which a mobile phone acquires program channel information based on a sound sample acquired from a TV set;

FIG. 3 is a block diagram of an operating circuit or system configuration of a mobile phone according to an embodiment of the present disclosure;

FIG. 4 is a functional block diagram illustrating an example configuration of a tuning means included in a mobile phone according to an embodiment of the present disclosure; and

FIG. 5 is a functional block diagram illustrating an example configuration of a channel information retrieval server according to an embodiment of the present disclosure.

### DETAILED DESCRIPTION OF THE EMBODIMENTS

The interchangeable terms “electronic apparatus” and “electronic device” include a portable radio communication apparatus. The term “portable radio communication apparatus”, which hereinafter is referred to as a “mobile terminal”, “portable electronic device”, or “portable communication device”, comprises all apparatuses such as mobile telephones, pagers, communicators, electronic organizers, personal digital assistants (PDAs), smartphones, portable communication devices or the like.

In the present application, embodiments of the disclosure are described primarily in the context of a portable electronic device in the form of a mobile telephone (also referred to as “mobile phone”). However, it shall be appreciated that the disclosure is not limited to the context of a mobile telephone and may relate to any type of appropriate electronic apparatus having the function of photographing and sound recording.

The preferred embodiments of the present disclosure are described as follows in reference to the drawings.

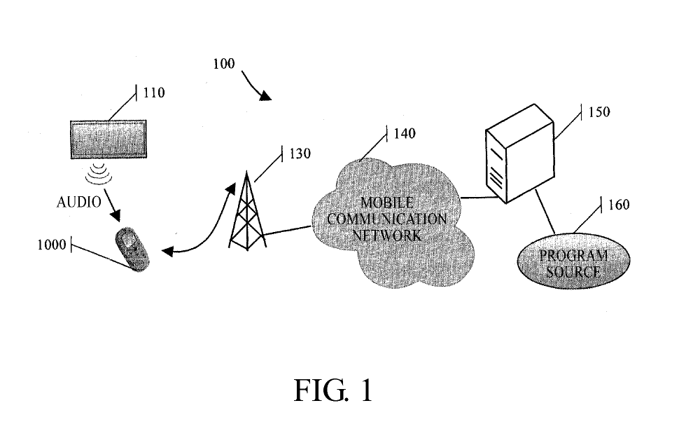

FIG. 1 is a schematic diagram illustrating an example configuration of a system 100 according to an embodiment of the present disclosure, in which a mobile phone that acquires program channel information based on a sound sample from a TV set.

As illustrated in FIG. 1, in case that the user watches a program of a certain channel played by a TV set (or other broadcast program sources) 110, or the user clearly hears the sound of the program played by the TV set 110 while not sitting in front of the TV set 110 to watch the played program, if the user has to leave due to other things or for some reason and does not want to miss the program being played, he may consider continuing to watch the program after leaving by using a mobile phone 1000 carried with himself, and this requires to know the channel being played by the TV set 110. Conventionally, this, for example, may be realized by viewing the channel information displayed on the picture of the TV set 110 or on a control device associated with the TV set, e.g., a tuner, set top box, and so on. Subsequently, the user can watch the program being played by the TV set 110 through the mobile phone 1000 by tuning for example the mobile TV application of the mobile phone 1000 according to the channel information viewed, but this requires excessive intervention by the user, and is not very convenient. In addition, in case that the user is not in front of the TV set 110, it is a little troublesome for the user to specially come up to the TV set 110 to view the channel information. Furthermore, sometimes it is inconvenient for the user to come up to the TV set 110 due to some reason.

According to an embodiment of the present disclosure, the mobile phone 1000 has a function of automatically acquiring channel information via a communication network based on a sound sample from the TV set 110, and then receiving and playing a program, e.g., the program played on the channel identified by the acquired channel information.

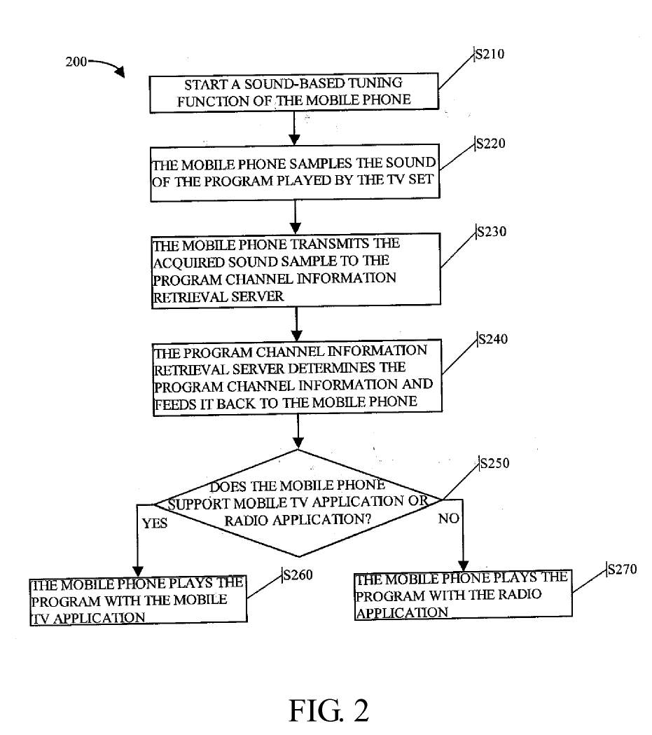

A procedure in which a mobile phone acquires program channel information based on a sound sample from a TV set according to an embodiment of the present disclosure so as to receive and play a program is described in details as follows by continuing referring to FIG. 1 and in conjunction with a flowchart 200 in FIG. 2.

In step S210, the user hopes to track and play a program currently being played by the TV set 110 with the mobile phone 1000, and thus starts a sound sample-based tuning function embedded in the mobile phone 1000.

Next, in step S220, with respect to the program currently being played by the TV set 110, the mobile phone 1000 samples received audio information of the program in a predetermined format to acquire a sound sample of a first predetermined period of time (e.g., 5 to 10 seconds (the designation “s” as a suffix to a number value means “seconds” herein, e.g., as in 5 s to 10 s, and so on). The predetermined format for example specifies a sampling rate, a data compression format, etc. of the sound sample. This first predetermined period of time may be longer or shorter than that just mentioned, as desired and/oras needed to carry out successful operation of the mobile phone 1000, as is described herein.

Next, in step S230, the mobile phone 1000 may transmit, via a communication network (e.g., via a base station 130 and a mobile communication network 140, or some other some other network), the sound sample acquired in step S220 to a program channel information retrieval server 150 connected to the mobile communication network 140. The program channel information retrieval server 150 is connected to a program source 160. The program source 160 and the program channel information retrieval server 150 are briefly described as follows.

The program source 160 for example may include a CCTV program supplier that provides a signal transmission stream multiplexing a plurality of programs (i.e., audio/video data streams of a plurality of program channels) to receiving terminals (e.g., digital set top boxes) over a cable TV network. There may be other program sources 160, for example program suppliers that transmit programs through satellite broadcast or in some other way. FIG. 1 illustrates that only one program source 160 is connected to the program channel information retrieval server 150, but it will be appreciated that multiple program sources 160 may be connected to the program channel information retrieval server 150. After receiving the signal transmission stream transmitted by the program source 160, the receiving terminal may de-multiplex and decode the signal transmission stream, so as to recover the audio/video data streams of the program channels. When a playing apparatus (e.g., a TV set) coupled with the receiving terminal is tuned to a certain channel, the playing apparatus will acquire program data corresponding to the channel so as to play the corresponding program.

The program channel information retrieval server 150 connected to the program source 160 tracks, demultiplexes and decodes in real-time, audio information of the program channels of the program source 160; acquires a sound sample of a second predetermined period of time (e.g., 30 to 60 seconds) in a format same as that of the sound sample acquired by the mobile phone 1000, based on the decoded audio information with respect to each of the program channels of the program source 160; and stores the sound sample, in association with the corresponding program channel information, into a program channel information database. The program information database may be stored in the program channel information retrieval server 150, e.g., in a memory thereof, or elsewhere, e.g., in a remote location and/or in another device. The program channel information database may be updated in a predetermined interval (e.g., 1 s) or some other longer or shorter interval.

Next, in step S240, the program channel information retrieval server 150 compares the sound sample received from the mobile phone 1000 with the sound samples associated with respective program channels of respective program sources stored in the program channel information database, so as to determine program channel information corresponding to the received sound sample, and feeds back the determined program channel information to the mobile phone 1000 via a communication network (including the mobile communication network 140 and the base station 130).

As an example, correlation operations may be carried out respectively on the sound sample transmitted from the mobile phone 1000 and the sound samples stored in the program channel information retrieval server 150, and if an obvious peak, e.g., an obvious correlation peak, occurs in a result of correlation operation on the sound sample transmitted from the mobile phone 1000 and one of the sound samples stored in the program channel information retrieval server 150, or the correlation peak is the maximum, e.g., closest match of respective transmitted signals and stored sound signals, among the results of all correlation operations, it can be determined that the sound sample transmitted from the mobile phone 1000 and the one sound sample stored in the program channel information retrieval server 150 are both corresponding to a same program, thus the program channel information can be determined.

Next, in step S250, the mobile phone 1000 determines whether it supports a mobile TV application or radio application.

If it is determined in step S250 that the mobile phone 1000 supports a mobile TV application (“YES” in step S250), the procedure will move to step S260, in which the mobile phone 1000 starts the mobile TV application, tunes to a proper program channel based on the received program channel information fed by the program channel information retrieval server 150, so as to receive over the network 140 and play a program corresponding to the program channel.

If it is determined in step S250 that the mobile phone 1000 does not support mobile TV application but supports a radio application (“NO” in step S250), the procedure will move to step S270, in which the mobile phone 1000 attempts to tune the radio application to a proper channel based on the received program channel information, so as to receive over the network 140 and play audios in a program corresponding to the program channel.

Thus, the user needs not to know the channel of the program being played by the TV set 110, and can conveniently acquire channel information of the program from the network 140 based on a sound sample of audio in the program being played acquired by the mobile phone 1000, so as to automatically complete channel tuning of the mobile phone 1000, and play the program with the mobile phone 1000.

Although only one program channel information retrieval server 150 is shown in FIG. 1, it will be appreciated that a plurality of program channel information retrieval servers 150 may be interconnected through a network to constitute an entire program channel information retrieval service center to provide services to the outside. For example, one program channel information retrieval server 150 is connected to all program sources 160 in an area/country, and the program channel information retrieval servers 150 in the whole county/world may be interconnected through a network such as the Internet. Thus, a user in any area where TV programs are receivable and mobile communications are available can conveniently acquire program channel information by using a mobile phone carried with him based on a sound sample of audios in the program being played by the TV set, so as to tune the mobile phone to a proper channel and receive over the network and play the program being played by the TV set.

In that case, preferably, the program channel information retrieval server 150 or the program channel information retrieval service center composed of a plurality of program channel information retrieval servers 150 may select a program source corresponding to a location of the mobile phone 1000, which can be determined by the network, and preferentially compare the received sound sample with the sound samples associated with respective program channels of the selected program source stored in the program channel information database, so as to determine the program channel information. In case that the service covers a large extent (e.g., the whole county, even the whole world), the program sources are numerous, therefore, the retrieval speed can be greatly improved by retrieving program channel information based on the location information of the mobile phone 1000. In the mobile communication system, conventional technical means may be used to acquire the location of the mobile phone 1000 through the home base station. In that case, location information of the mobile phone 1000 is transmitted, together with the sound sample acquired by the mobile phone 1000, to the program channel information retrieval server 150 or the program channel information retrieval service center composed of the program channel information retrieval servers 150.

As mentioned above, the mobile phone 1000 acquires the sound sample of the first predetermined period of time, while the program channel information retrieval server 150 acquires and stores the sound sample of the second predetermined period of time. In order to carry out an effective matching and comparison between the two sound samples, it should be ensured that the two predetermined periods of time can overlap a minimum sound sample duration for comparing sounds (a minimum comparison window) (e.g., 5 s), and the minimum comparison window is a minimum time span enabling a definite judgment of correlation between the two sound samples. The first predetermined period of time is usually set to be longer than the minimum comparison window, for example, the first predetermined period of time may be set as 5 to 10 s. But in consideration of delay of wireless communication, the first predetermined period of time should not be set too long, so that the sound sample acquired by the mobile phone 1000 can be transmitted to the program channel information retrieval server 150 in time. The second predetermined period of time is usually set relatively long so that there is always a sound sample in the program channel information database that can at least overlap a time span of the minimum comparison window with the sound sample transmitted from the mobile phone 1000, e.g., may be set as 30 to 60 s. For example, the second predetermined period of time may be determined at least based on the first predetermined period, a maximum transmission delay (e.g., 2 s) for transmitting the sound sample from the mobile phone 1000 to the program channel information retrieval server 150, a time interval for dynamically updating the program channel information database, and the minimum comparison window.

The above-described flowchart 200 is just exemplary and illustrative. The method according to the present disclosure does not necessarily include each of the above steps, and some of the steps can be deleted, combined or order-reversed. These modifications are all included within the scope of the present disclosure without deviating from the spirit and scope of the present disclosure.

In addition, if in step S230 the mobile phone 1000 fails to successfully transmit the acquired sound sample to the program channel information retrieval server 150 within a predetermined time, then, the mobile phone 1000 may re-sample and transmit the sound of the program being played by the TV set 110, so as to avoid a situation that the program channel information retrieval server 150 cannot find in the program channel information database a sound sample matching the sound sample received from the mobile phone 1000 due to time difference.

In addition, there may be a situation in the practice that multiple channels play a same program synchronously. In this case, the program channel information retrieval server 150 will find in the program channel information database multiple pieces of program channel information matching the received sound sample. Preferably, the program channel information retrieval server 150 transmits all the program channel information representing all those matches to the mobile phone 1000 for the user's selection.

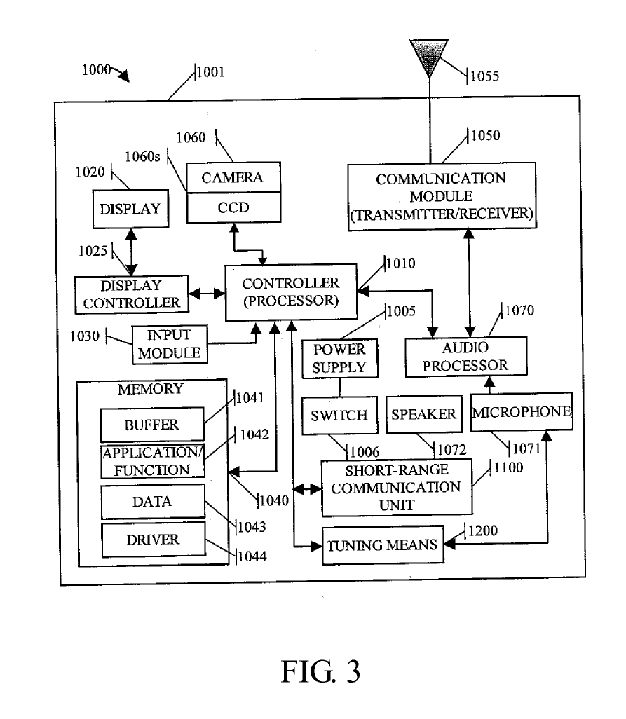

FIG. 3 illustrates a block diagram of an operating circuit 1001 or system configuration of the mobile phone 1000 according to an embodiment of the present disclosure, including a tuning means 1200 according to an embodiment of the present disclosure. The drawing is exemplary and other type of circuit may also be used to supplement or replace the operating circuit to realize telecom function or other function. The operating circuit 1001 includes a controller 1010 (sometimes called as processor or operation control, which may include microprocessor or other processing means and/or logic means) that receives an input and controls respective parts and operations of the operating circuit 1001. An input module 1030 provides an input to the controller 1010. The input module 1030 for example is a key or touch input means. A camera 1060 may include a lens, a shutter and an image sensor 1060s (e.g., digital image sensor such as Charge Coupled Apparatus (CCD), CMOS apparatus, or other image sensor). The image detected by the image sensor 1060s can be provided to the controller 1010 for a usage in conventional way, e.g., storage, transmission, etc.

A display controller 1025 responds to an input from a touch-screen display 1020 or other type of display 1020 capable of providing input to the display controller 1025. Thus, for example, a touch by a stylus or finger on a portion of the touch-screen display 1020, e.g., selection of picture on displayed picture list, selection of icon or function in Graphical User Interface (GUI) displayed on the display 1020, can provide an input to the controller 1010 in a conventional way. The display controller 1025 may further receive an input from the controller 1010 to display image, icon, information, etc. on the display 1020. The input module 1030 for example may be a key and/or a signal-conditioning circuit, a decoding circuit or other appropriate circuit for providing information indicating operating one or more keys in conventional way.

A memory 1040 is coupled to the controller 1010. The memory 1040 may be a solid state memory such as ROM, RAM, SIM card, etc., and may also be such a memory that stores information even if power is off, capable of being selectively erased and provided with more data, and the example of the memory sometimes is called as EPROM. The memory 1040 may be a device of other type. The memory may be or may include a non-transitory memory. The memory 1040 includes a buffer memory 1041 (sometimes called as buffer). The memory 1040 may further include an application/function storage unit 1042 for storing application programs and function programs or performing routine of operation of the mobile phone 1000 through the controller 1010. The memory 1040 may further include a data storage unit for storing data, e.g., contact person, digital data, picture, sound and/or any other data used by the mobile phone 1000. A driver storage unit 1044 of the memory 1040 may include various drivers of the mobile phone 1000 for communication function and/or performing other functions (e.g., messaging application, address book application, etc.) of the mobile phone 1000.

The mobile phone 1000 includes a telecom unit. The telecom unit for example includes a communication module 1050, i.e., a transmitter/receiver 1050 for transmitting outgoing signal and receiving incoming signal via an antenna 1055. The communication module (transmitter/receiver) 1050 is coupled to the controller 1010 to provide input signal and receive output signal, which may be same as the structure and/or operation or the condition of a conventional mobile phone. The communication module (transmitter/receiver) 1050 is also coupled to a speaker 1072 and a microphone 1071 to provide audio output via the speaker 1072, and receive audio input from the microphone 1071, so as to realize a normal telecom function. The speaker 1072 and the microphone 1071 enable the user to listen and speak via the mobile phone 1000. An audio processor 1070 may include any appropriate buffer, decoder, amplifier, etc. In addition, the audio processor 1070 is coupled to the controller 1010, so as to record sound locally via the microphone 1071, and play sound stored locally via the speaker 1072.

The mobile phone 1000 further includes a power supply 1005 capable of being coupled so as to supply electric power to the operating circuit 1001 after an ON/OFF switch 1006 is closed.

With respect to telecom function and/or various other applications and/or functions selectable from the GUI, the mobile phone 1000 may be operated in a conventional way. For example, the mobile phone 1000 may initiate and receive a phone call, play music, picture, video, movie, etc., take and store photo or video, fabricate, store, maintain and display file and database (e.g., contact person or other database), browse Internet, remind calendar, etc.

The mobile phone 1000 further includes a short-range communication unit 1100 capable of carrying out a short-range communication between the mobile phone 1000 and other apparatus for example via Bluetooth connection or other wireless transmission way. For example, when two apparatuses are several meters away or closer, a communication can be carried out through the short-range communication unit 1100 to transmit files and synchronize data, etc.

The typical configuration of the mobile phone 1000 is described above, but it will be apparent to a person skilled in the art that a mobile phone according to the present disclosure does not include all components of the above configuration necessarily. The scope of the present disclosure is defined by the claims.

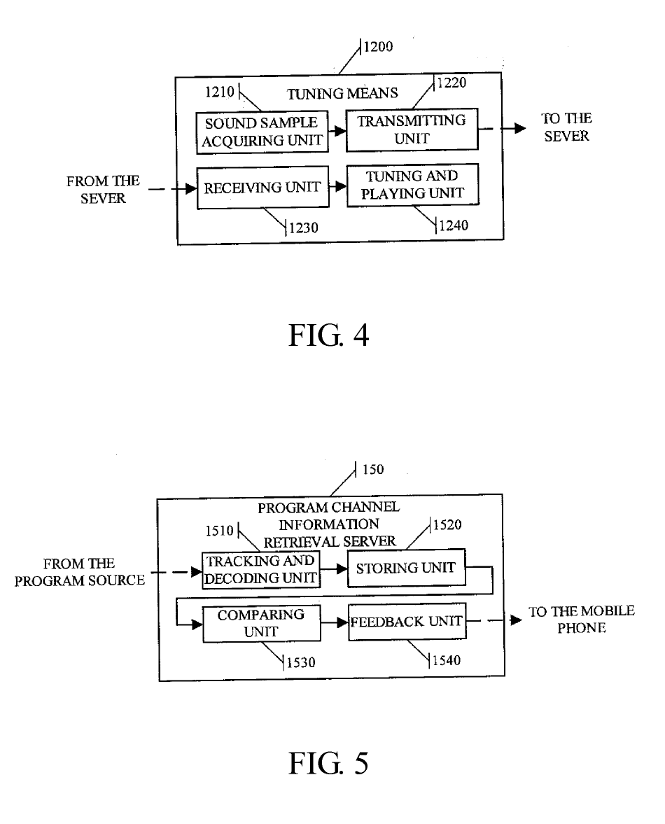

The configurations of the tuning device, circuit, means, etc. 1200 included in the mobile phone 1000 and the program channel information retrieval server 150 according to an embodiment of the present disclosure are described as follows with reference to FIGS. 4 and 5 respectively.

FIG. 4 is a functional block diagram illustrating an example configuration of the tuning means 1200, e.g., tuning device, circuit, etc., included in the mobile phone 1000 according to an embodiment of the present disclosure.

As illustrated in FIG. 4, the tuning means 1200 may include a sound sample acquiring unit 1210, a transmitting unit 1220, a receiving unit 1230 and a tuning and playing unit 1240.

The sound sample acquiring unit 1210 may be configured to acquire a sound sample of a first predetermined period of time in a predetermined format from a program including audios being played by a program playing source (e.g., a TV set 110). The predetermined format for example specifies a sampling rate and a data compression format of the sound sample. The setting of the first predetermined period of time is described as previously.

The transmitting unit 1220 may be configured to transmit, through a communication network (e.g., via the base station 130 and the mobile communication network 140), the sound sample acquired by the sound sample acquiring unit 1210 to the program channel information retrieval server 150 connected to the communication network. The configuration of the program channel information retrieval server 150 is described below with reference to FIG. 5.

The receiving unit 1230 may be configured to receive program channel information fed back by the program channel information retrieval server 150.

The tuning and playing unit 1240 may be configured to tune to an appropriate program channel based on the program channel information received by the receiving unit 1230, so as to receive over the network 140 and play a program corresponding to the program channel information.

In addition, the tuning and playing unit 1240 may be further configured to, based on the program channel information received by the receiving unit 1230 and program playing applications (e.g., a mobile TV application or a radio application) supported by the mobile phone 1000, select an appropriate program playing application to play the program corresponding to the program channel information.

If the program channel information received by the receiving unit 1230 indicates a TV program source and the mobile phone 1000 supports the mobile TV application, e.g., an application or software, etc. and/or associated hardware to play a TV program, the tuning and playing unit 1240 selects the mobile TV application to play the program corresponding to the program channel information. Otherwise, the tuning and playing unit 1240 may select the radio application, e.g., an application or software, etc., and/or associated hardware, to play audios of the program.

In addition, the tuning means 1200 may be further configured to, when the transmitting unit 1220 fails to successfully transmit the sound sample acquired by the sound sample acquiring unit 1210 to the program channel information retrieval server 150 within a predetermined time, instruct the sound sample acquiring unit 1210 to re-sample the sound of the program being played by the TV set 110, and then instruct the transmitting unit 1220 to transmit the re-sampled sound sample, so as to avoid the situation that the program channel information retrieval server 150 cannot find a sound sample matching the sound sample received from the mobile phone 1000 in the program channel information database due to time difference.

In addition, although not illustrated in the drawing, the tuning means 1200 may further include a program channel information presenting and selecting unit, which is configured to, in case that the receiving unit 1230 receives multiple pieces of program channel information from the program channel information retrieval server 150, present those program channel information to the user for the user's selection. Thus, the tuning and playing unit 1240 may receive and play a corresponding program based on the program channel information selected by the user.

FIG. 5 is a functional block diagram illustrating an example configuration of the channel information retrieval server 150 according to an embodiment of the present disclosure.

The channel information retrieval server 150 is connected to one or more program sources 160 (the term “source(s) means one or more sources, for example), and is configured to acquire and store in real-time, sound samples of a second predetermined period of time from audios of program channels of the program sources 160, compare the sound sample transmitted from the transmitting unit 1220 of the mobile phone 1000 with each of the stored sound samples, so as to determine program channel information corresponding to the sound sample transmitted from the transmitting unit 1220 of the mobile phone 1000, and feed back the determined program channel information to the mobile phone 1000 through the communication network. The setting of the second predetermined period of time has been described previously.

As illustrated in FIG. 5, the program channel information retrieval server 150 may include a tracking and decoding unit 1510, a storing unit 1520, a comparing unit 1530 and a feedback unit 1540.

The tracking and decoding unit 1510 may be configured to track and decode in real-time, audio information of program channels of at least one program source 160 connected to the program channel information retrieval server 150, and acquire sound samples of a second predetermined period of time in a predetermined format same as that of the sound sample acquired by the mobile phone 1000, based on the decoded audio information with respect to the program channels of the program sources.

In details, the tracking and decoding unit 1510 receives in real-time from each program source 160, a signal transmission stream multiplexing audio/video data streams of the program channels of the program source 160, demultiplexes and decodes the received signal transmission streams to restore the audio information of the program channels of the program sources, and then acquires sound samples of the second predetermined period of time in a predetermined format same as that of the sound sample acquired by the mobile phone 1000, based on the decoded audio information.

The storing unit 1520 may be configured to store, the program channel information of the program channels of the program sources 160 and the sound samples acquired by the tracking and decoding unit 1510 from the respective program channel, into a program channel information database, and update the program channel information database in a predetermined time interval.

The comparing unit 1530 may be configured to compare the sound sample received from the mobile phone 1000 with the sound samples associated with respective program channels of respective program sources 160 stored in the program channel information database, so as to determine program channel information corresponding to the received sound sample. The comparing unit 1530, for example, may carry out correlation operations respectively on the sound sample transmitted from the mobile phone 1000 and each of the sound samples stored in the program channel information database, and if an obvious correlation peak occurs in a result of correlation operation on the sound sample transmitted from the mobile phone 1000 and one of the sound samples stored in the program channel information database, or the correlation peak is the maximum among all the results of correlation operations, it can be determined that the sound sample transmitted from the mobile phone 1000 and the one sound sample stored in the program channel information database are both corresponding to a same program, thus the program channel information is determined.

The comparing unit 1530 may select, based on a location of the mobile phone 1000 determined by the network, a program source corresponding to the location, and preferentially compare the received sound sample with the sound samples associated with program channels of the selected program source stored in the program channel database, so as to determine the program channel information. This is especially advantageous in case that the service covers a large extent (e.g., the whole county, even the whole world) and the program sources are numerous, and the retrieval speed will be greatly improved. In the mobile communication system, acquiring the location of the mobile phone 1000 via the base station is conventional technical means. In this case, the location information of the mobile phone 1000 is transmitted in accompany with, e.g., together with, the sound sample acquired by the mobile phone 1000, to the channel information retrieval server 150 or the program channel information retrieval service center, which may include or be coupled to a plurality of program channel information retrieval servers 150.

Next, the feedback unit 1540 feeds back the determined program channel information to the mobile phone 1000 through the communication network (via the mobile communication network 140 and the base station 130), so that the mobile phone 1000 tunes to an appropriate program channel based on the program channel information to receive over the network and play the program corresponding to the program channel information.

There may be a situation that the comparing unit 1530 determines multiple pieces of program channel information for the sound sample received from the mobile phone 1000 (e.g., a same program is played in multiple channels synchronously). In this case, the feedback unit 1540 may feed back all the multiple pieces of program channel information determined by the comparing unit 1530 to the mobile phone 1000 for the user's selection.

It will be appreciated that various portions of the present disclosure can be implemented in hardware, software, firmware, or a combination thereof. In the described embodiments, a number of the steps or methods may be implemented in software or firmware that is stored in a memory and executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in the flow diagram or otherwise described herein may be understood as representing modules, fragments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood reasonably by those skilled in the art of the present disclosure.

The logic and/or steps represented in the flow diagrams or otherwise described herein, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this Specification, a “computer-readable medium” can be any means that can contain, store, communicate, propagate, or transport the program for use by or in combination with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection portion (electronic device) having one or more wires, a portable computer diskette (magnetic device), a random access memory (RAM) (electronic device), a read-only memory (ROM) (electronic device), an erasable programmable read-only memory (EPROM or Flash memory) (electronic device), an optical fiber (optical device), and a portable compact disc read-only memory (CDROM) (optical device). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and drawings depict the various features of the disclosure. It shall be appreciated that the appropriate computer code could be prepared by a person skilled in the art to carry out the various steps and processes described above and illustrated in the drawings. It also shall be appreciated that the various terminals, computers, servers, networks and the like described above may be of any type and that the computer code may be prepared to carry out the disclosure using such apparatus in accordance with the disclosure hereof.

Specific embodiments of the present disclosure are disclosed herein. A person skilled in the art will easily recognize that the disclosure may have other applications in other environments. In the fact, many embodiments and implementations are possible. The accompanied claims are in no way intended to limit the scope of the present disclosure to the specific embodiments described above. In addition, any recitation of “device configured to . . . ” is intended to evoke a device-plus-function reading of an element and a claim, whereas, any element that does not specifically use the recitation “device configured to . . . ”, is not intended to be read as a device-plus-function element, even if the claim otherwise includes the word “device”.

Although the present disclosure has been illustrated and described with respect to a certain preferred embodiment or multiple embodiments, it is obvious that equivalent alterations and modifications will occur to a person skilled in the art upon the reading and understanding of this specification and the accompanied drawings. In particular regard to the various functions performed by the above elements (components, assemblies, devices, compositions, etc.), the terms (including a reference to a “device”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the present disclosure. In addition, although a particular feature of the disclosure may have been described above with respect to only one or more of several illustrated embodiments, such feature may be combined with one or more other features of the other embodiments, as may be desired and advantageous for any given or particular application.

What is claimed is:

1. An apparatus for tuning to a program channel based on a sound sample in a mobile communication terminal, comprising:
a sound sample acquiring unit configured to acquire a sound sample of a predetermined period of time in a predetermined format from a program comprising audio being played by a program playing source;
a transmitting unit configured to transmit the sound sample acquired by the sound sample acquiring unit to a server over a network, so as to acquire corresponding program channel information based on the sound sample;
a receiving unit configured to receive the acquired program channel information; and
a tuning and playing unit configured to tune to an appropriate program channel based on the program channel information received by the receiving unit, so as to receive over the network and play a program corresponding to the program channel information.

2. The apparatus according to claim 1, wherein the predetermined period of time is longer than predetermined minimum sound sample duration for acquiring program channel information based on the sound sample.

3. The apparatus according to claim 1, wherein the tuning and playing unit is further configured to, based on the program channel information received by the receiving unit and program playing applications supported by the mobile communication terminal, select an appropriate one of the program playing applications to play the program corresponding to the program channel information.

4. The apparatus according to claim 3, wherein the mobile communication terminal includes a mobile TV application,
and wherein, when the program channel information received by the receiving unit indicates a TV program source, the tuning and playing unit selects the mobile TV application to play the program corresponding to the program channel information.

5. The apparatus according to claim 1, further comprising a program channel information presenting and selecting unit configured to, when the receiving unit receives more than one piece of program channel information, present the more than one piece of program channel information to the user for the user's selection, and
wherein the tuning and playing unit is further configured to, based on the program channel information selected by the user through the program channel information presenting and selecting unit, tune to an appropriate channel so as to receive over the network and play the program corresponding to the selected program channel information.

6. The apparatus according to claim 1, wherein the sound sample acquiring unit is configured to re-acquire a sound sample of the program when the transmitting unit fails to successfully transmit the sound sample acquired by the sound sample acquiring unit to the server over the network within predetermined time.

7. A mobile communication terminal, comprising the apparatus according to any of claims 1 to 6.

8. A method for tuning to a program channel based on a sound sample in a mobile communication terminal, comprising:
activating a sound sample-based tuning function of the mobile communication terminal;
acquiring, by the mobile communication terminal, a sound sample of a predetermined period of time in a predetermined format from a program comprising audio played by a program playing source;
transmitting, by the mobile communication terminal, the acquired sound sample to a server over a network, so as to acquire corresponding program channel information based on the sound sample; and
tuning, by the mobile communication terminal, to an appropriate program channel based on the received program channel information, so as to receive over the network and play a program corresponding to the program channel information.

9. The method according to claim 8, wherein said acquiring comprises acquiring a sound sample of a predetermined period of time that is longer than predetermined minimum sound sample duration for acquiring program channel information based on the sound sample.

10. The method according to claim 8, wherein the step of tuning comprises playing the program, including selecting, by the mobile communication terminal, based on the received program channel information and program playing applications supported by the mobile communication terminal, an appropriate one of the program playing applications to play the program corresponding to the program channel information.

11. The method according to claim 10, wherein when the program channel information received by the mobile communication terminal indicates a TV program source, and if the mobile communication terminal comprises a mobile TV application, said playing the program comprises laying the program corresponding to the program channel information by the mobile TV application.

12. The method according to claim 8, further comprising:
when more than one piece of program channel information is received, presenting the more than one piece of program channel information to the user for the user's selection, and
wherein the step of tuning further comprises: based on the program channel information selected by the user, tuning to an appropriate channel so as to receive over the network and playing the program corresponding to the selected program channel information.

13. The method according to claim 8, further comprising:
if the acquired sound sample is not successfully transmitted to the server over the network within the predetermined time, re-acquiring a sound sample of the program.

14. A program channel information retrieval server, comprising:
a tracking and decoding unit configured to track and decode in real-time, audio information of program channels of at least one program source connected to the server, and acquire a sound sample of a first predetermined period of time in a predetermined format, based on the decoded audio information with respect to the program channels of the program source(s);
a storing unit configured to store the program channel information of the program channels of the program source(s) and the sound samples acquired by the tracking and decoding unit in a predetermined time interval with respect to the program channels, into a database in association with each other;
a comparing unit configured to compare a sound sample of a second predetermined period of time received from a mobile communication terminal via a network with the sound samples associated with the program channels of the program source(s) stored in the database, so as to determine program channel information corresponding to the received sound sample, wherein the sound sample of the second predetermined period of time is acquired by the mobile communication terminal in the predetermined format with respect to a program comprising audio being played by a program playing source; and
a feedback unit configured to feed back the determined program channel information to the mobile communication terminal via the network, so that the mobile communication terminal is capable of tuning to an appropriate program channel based on the fed back program channel information to receive and play the program corresponding to the program channel information.

15. The program channel information retrieval server according to claim 14, wherein the tracking and decoding unit is further configured to receive in real-time from each program source, a transmission stream multiplexing audio/video data streams of program channels of the program source, so as to decode audio information of each program channel of the program source from the received transmission stream.

16. The program channel information retrieval server according to claim 14, wherein the first predetermined period is determined at least based on the second predetermined period, a transmission delay for transmitting the sound sample from the mobile communication terminal to the program channel information retrieval server, the predetermined time interval and a minimum sound sample duration for acquiring program channel information through sound comparison.

17. The program channel information retrieval server according to claim 14, wherein the comparing unit is further configured to select, based on a location of the mobile communication terminal determined by the network, a program source corresponding to the location and compare the received sound sample with the sound samples associated with respective program channels of the selected program source stored in the database.

18. The program channel information retrieval server according to claim 14, wherein the comparing unit is further configured to carry out correlation operations respectively on the sound sample transmitted from the mobile communication terminal and the sound samples associated with respective program channels stored in the database, and if an obvious peak occurs in a result of correlation operation on the sound sample transmitted from the mobile communication terminal and one of the sound samples stored in the database, as compared with the results of other correlation operations, determine that a program channel corresponding to the one sound sample is the program channel being played by the program playing source when the mobile communication terminal acquires the sound sample.

19. A method for acquiring program channel information based on a sound sample in a program channel information retrieval server connected to at least one program source so as to acquire program related information from the at least one program source, comprising:
tracking and decoding in real-time, audio information of program channels of the at least one program source;
acquiring a sound sample of a first predetermined period of time in a predetermined format, based on the decoded audio information with respect to the program channels of the at least one program source;
storing the program channel information of the program channels of the at least one program source and sound samples acquired in a predetermined time interval with respect to the program channels, into a database in association with each other;
receiving a sound sample of a second predetermined period of time in the predetermined format from a mobile communication terminal;
comparing the received sound sample with the sound samples associated with the program channels of the at least one program source stored in the database, so as to determine program channel information corresponding to the received sound sample; and
feeding back the determined program channel information to the mobile communication terminal.

20. The method according to claim 19, wherein the step of tracking and decoding in real-time, audio information of program channels of the at least one program source comprises:
receiving in real-time from each program source, a transmission stream multiplexing audio/video data streams of the program channels of the program source, and decoding audio information of the program channels of the program source from the received transmission stream.

21. The method according to claim 19, wherein the first predetermined period is determined at least based on the second predetermined period, a transmission delay for transmitting the sound sample from the mobile communication terminal to the program channel information retrieval server, the predetermined time interval and minimum sound sample duration for acquiring program channel information through sound comparison.

22. The method according to claim 19, wherein the step of comparing the sound samples comprises:
selecting, based on a location of the mobile communication terminal transmitted together with the sound sample acquired by the mobile communication terminal, a program source corresponding to the location and compare the received sound sample with the sound samples associated with respective program channels of the selected program source stored in the database.

23. The method according to claim 19, wherein the step of comparing the sound samples comprises:
carrying out correlation operations respectively on the sound sample transmitted from the mobile communication terminal and the sound samples associated with the program channels stored in the database; and
if an obvious peak occurs in a result of correlation operation on the sound sample transmitted from the mobile communication terminal and one of the sound samples stored in the database, as compared with the results of other correlation operations, determining that a program channel corresponding to the one sound sample is the program channel played by the program playing source when the mobile communication terminal acquires the sound sample.

24. A system for determining program channel information based on a sound sample, comprising the mobile communication terminal according to claim 7, and the program channel information retrieval server according to any of claims 14 to 18.
